(19) United States
(12) Patent Application Publication
(10) Pub. No.: US 2013/0135208 A1
(43) Pub. Date: May 30, 2013

(54) Method for a chord input of textual, symbolic or numerical information

(71) Applicant: ALEKSANDR A. VOLKOV, SAN FRANCISCO, CA (US)

(72) Inventor: ALEKSANDR A. VOLKOV, SAN FRANCISCO, CA (US)

(21) Appl. No.: 13/304,651

(22) Filed: Nov. 27, 2011

(51) Int. Cl. G06F 3/02

(52) U.S. Cl. 345/168

(57) ABSTRACT

A system and method for chord input of symbols, by up to three fingers of each hand. The system consists of twelve input zones (2), two for each finger, positioned to match the grip of the hand. For one of the proposed embodiments, a handheld device (3), input zones are on device's back (1) in order to face the fingers of the holding hand. Entry is achieved by simultaneous activation of the zones by the fingers (“chord” or “pattern”), decoded by a translation patterns' table, to a desired symbol. Invention permits the fingers to reside at predetermined positions and move only along one axis, eliminating a need to find a spot for placing a finger, and minimizing the time required to make decisions on where to move. And since only two fingers of each hand are required for most of the symbols, method is a fast, effective and error-prone.

### CROSS-REFERENCE TO RELATED APPLICATIONS

Not applicable.

### FEDERALLY SPONSORED RESEARCH

Not applicable.

### TECHNICAL FIELD OF THE INVENTION

This present invention relates to the method of text, symbol and number input (collectively referred to here as “text”), particularly based on the principle of chord input achieved by activation of one, or a combination of several, specifically mapped area(s) on the input device. Such method allows for alternative text input, utilizing the natural features of the human hand, and therefore is more applicable in handheld and mobile applications and devices, rather than a more commonly used traditional keyboard layout (also known as the “qwerty” layout standard).

Additionally, by primarily utilizing only two fingers of each hand, this method and its proposed embodiments of text input allows for an intuitive, blind, and more effective chord input, leaving one finger for additional functionality and two other fingers of each hand free to hold and to manipulate the device for its direct application (other than the text input function).

### BACKGROUND OF THE INVENTION

Technical progress and the evolution of computers and other computerized devices advance at a rapid pace. Certain tendencies and direction of this development can be noted: (a) miniaturization—devices become smaller; (b) decrease of the cost—devices become cheaper; and (c) gain of power—devices become more capable, usable in an ever increasing number of situations, and faster in functioning in these applications. Similar changes are evident with respect to the effectiveness and cost of communications, both cellular and Internet based. Together, these tendencies result in a shift toward a more mobile and miniaturized computing devices, and the consumers have increased expectations for better and easier ways to connect and to communicate.

The form of the communications tends to be increasingly more textual. Even traditional voice phone calls are currently in a decline, while text-messaging becomes increasingly more popular. According to the studies conducted by the Pew Research Center, the difference between the Fall of 2009 and the Spring of 2011 in text messaging is almost a 40% increase (from 29.7 to 41.5 messages per day), while the decrease in phone calls is 61% (from 13 to 5 calls per day)¹. On average, 73% of US cell phone users today use text messaging at least occasionally, while 31% of US cell phone users prefer to be texted rather than called. From this group, a 95% share of the users from the age group 18-29 prefers text messaging. These trends signal the increasing importance of text input and its guaranteed significance in the future. ¹ http://pewinternet.org/Reports/2011/Cell-Phone-Texting-2011/Summary-of-Findings.aspx

### PRIOR ART

Not everything evolves at the same speed as computer technology. With a few rare exceptions, all modern devices continue to utilize the same common keyboard layout, principally left unchanged for the last 75-133 years². Those text-input solutions were celebrated for solving the problem of rapid typing on the mechanical typewriters—devices grossly limited in their functionality by today's standards. For instance, out of all contemplated designs offered during that era, only the ones with the straight rows of buttons survived the test of time, because that mechanical solution of an almost instantaneous advance and release of several levers (with bars, each carrying a letter to imprint on paper) could only efficiently work if all bars were positioned in a certain way, at equal distance of each other. ² Latham Sholes patented QWERTY layout in 1878. Dr. August Dvorak patented DVORAK layout in 1936. Both were invented for use with the mechanical typewriters.

Typing devices today need not account for the position of mechanical levers. Technology reached a point where the actual physical act of causing a symbol to appear on the desired device can be accomplished with freely positioned and styled buttons, sensors, or even by a stroke on a screen. Thus, technology has already liberated us from the necessity to adhere to a traditional linear layout from the past. With the capacities of modern technology, the number of possibilities for styling text input is virtually indefinite. The traditional keyboard does not fit the natural grip positioning of the human hand (more on it below), and it is even more grotesque and uncomfortable to use when squeezed to apply in miniaturized and handheld devices.

Squeezing a traditional keyboard onto the modern devices faces an engineering conflict—while devices strive to be lightweight, mobile, easy in operation, and with minimal possible number of parts involved, implementation of an equivalent of traditional keyboard occupies space (either on the device or within its precious screen space); and when physically added (as opposed to just a virtual implementation drawn on the screen), it adds to the device's weight, thickness and complexity, and creates additional parts that can be broken. Operating a traditional keyboard on handheld devices requires visual control, because of the miniature buttons and high possibility of a mistake. Also, it is impossible to include a traditional keyboard in form factors below a certain level of miniaturization, because the set of the buttons would be so small that the human finger would not be able to press the required button without engaging a few neighboring ones.

Attempts have been made before to allow a person to input information by pressing buttons in certain combinations, whereas a set of few buttons would allow its user to enter any symbol, based on the unique combination of the buttons pressed (the so-called “chord” input). However, none of the previously offered systems had achieved noticeable recognition or have been implemented in widely used applications. This is because those earlier chord-input solutions were not intuitive enough to allow a human to operate the device naturally, which is especially critical when the input areas are positioned on the back of the device, therefore requiring a blind operation, without seeing what buttons are pressed. Those solutions are also cumbersome as their entire set of symbols is divided into several sub-sets (or “cases”). The operator of this kind of layout of symbols is therefore required to constantly switch between sub-sets in order to have different symbols entered.

### ADVANTAGES

This void in the art calls for a radically new solution, to allow human hands to operate freely and naturally, without compromising the speed and quality of text input, while not being constrained by the outdated rigid standards of the mechanical past. The limitations and inconveniences of the earlier chord-input solutions have to be addressed too. This invention is the result of an endeavor to find the most effective way.

Ergonomic Advantage Vs. Traditional Keyboards

One of the fundamental premises of this invention is to utilize a human's most natural and intuitive hand position when it grips an object. As much as it may appear that the keyboards evolved slowly, stretched over the last 150 years, it is still amazingly fast when compared to the pace of our own evolution. Humans had not changed their grip approach since early hominids, while the development our palm itself took millions of years³. The way people hold their phones today is dictated by our bones, ligaments and muscle structure, as it has formed naturally over the ages. ³ http://www.ncbi.nlm.nih.gov/pmc/articles/PMC1571064/

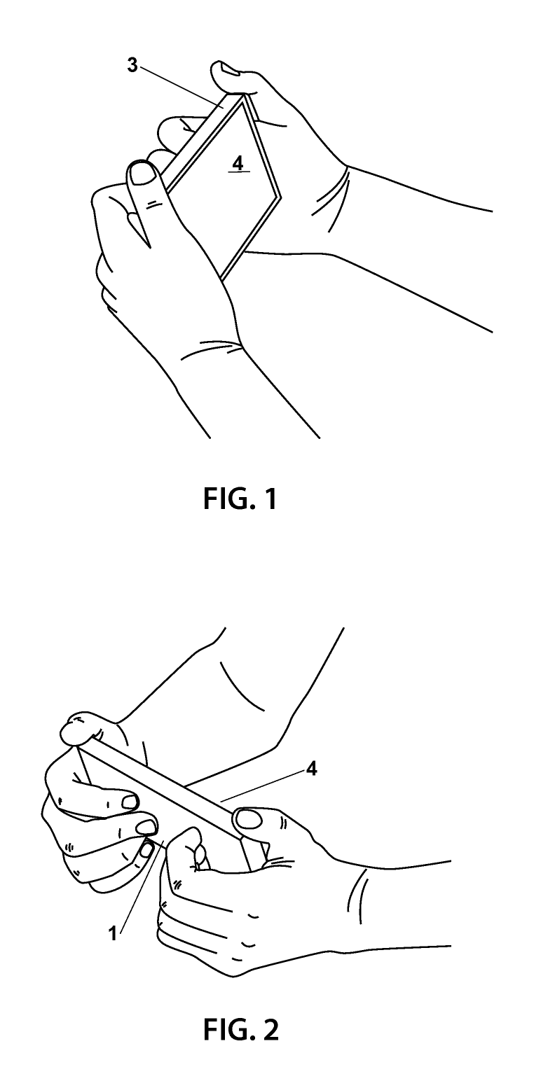

A human's most natural hand gripping position can be achieved by resting the device on the upper part of the palm (the metacarpus area), pressed by only thumbs against the palm and supported by other fingers in the back, for a device held by two hands [FIG. 1, FIG. 2]. This invention allows the device user to perform text input while holding her device in this natural way. Moreover, by eliminating the need for a hand to change its position (unlike in a traditional keyboard layout, where fingers have to move to find the necessary buttons), this invention makes text input possible in situations or devices where it was not applicable before, or for people whose motor control or inability to move hands were preventing them from using traditional keyboards.

Ergonomic Advantage Vs. Chord Keyboards

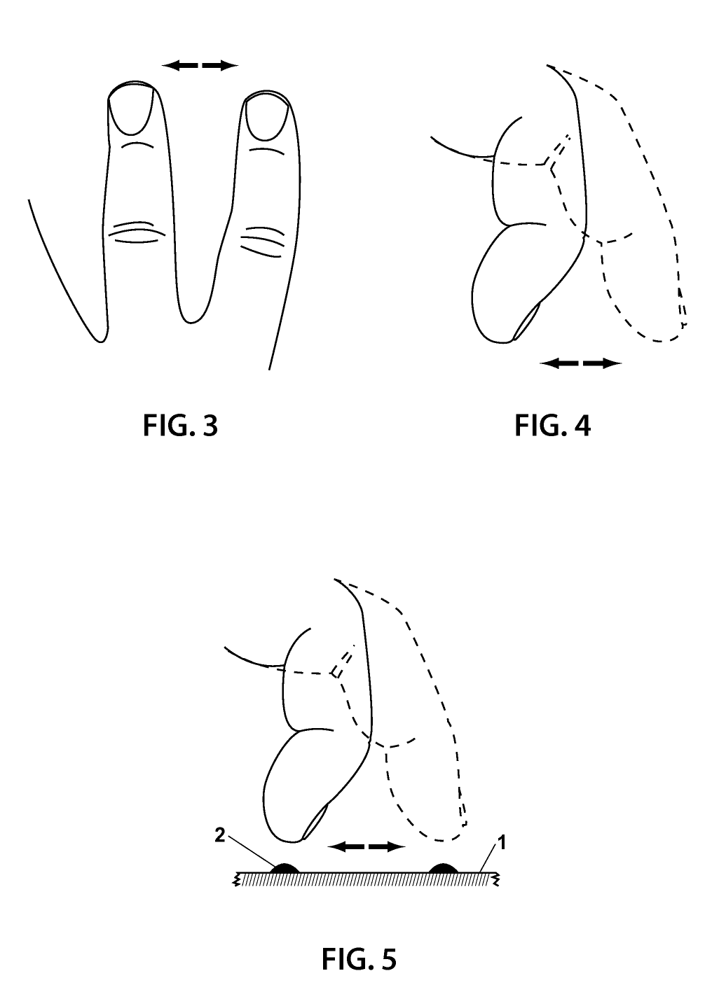

The proposed method of chord input offered by this invention is superior to the previously designed methods, because (a) it utilizes at most 3 fingers of each hand, with the majority of all needed symbols (including other national layouts) reachable by just two fingers and third finger assigned for additional functionality and features; (b) the two fingers used (index and middle) are the fingers with the best developed motor control; (c) this invention requires fingers only to move in their most natural direction—to bend along their bone axial line (Flexion/Extension) [FIG. 4] and never sideways (Adduction/Abduction) [as shown on FIG. 3]; (d) this invention offers the easiest blind operation, because the user's fingers are not required to seek its position and are always fixed above their assigned row of two input zones to work with.

Productivity Advantage

This invention focuses not only on the hand convenience in operation, but also on a related aspect of operation productivity. This method cuts the time of entering of any symbol (since the time to search for a correct button and time to move across the keyboard are extremely minimized), and also removes the need for visual control over both the hands and the keyboard. This method thus allows for the blind entry of symbols, while not requiring extensive training to memorize a keyboard's layout, which is what all professional typists had to do for the last century.

Economic Advantage

The proposed invention is cheaper in implementation than a traditional keyboard, in any field or embodiment where physical buttons or sensors are used. This is achieved by the simple fact of using only 12 buttons or censors vs. the 101 used in the standard keyboard. Since this invention requires no visual control over text input on a device's back side, a set of the input zones can be materialized in the form of a sensor screen (optical, thermal, or pressure-controlled).

Expansion Advantage

Additionally, this invention opens the possibility of textual input in the devices or situations not open for the conventional keyboard, or where the visual control over entering text is impossible or difficult. Such situations include one- and two-hand manipulators, steering wheels, holders utilized by disabled people, particularly ones with limited motor control or vision impairment.

Conclusion

This invention offers an effective and ergonomic method for the human hand to input text, by utilizing the hand's natural position, with a minimal number of fingers involved, and with no visual control or palm movement required.

Particularly, it permits to enter a complete set of all the necessary symbols of any national keyboard without switching between several sub-sets of keys (or “cases”), and to have it done “blindly”, without the need for visual control. This invention also permits to enter all the necessary letters by only two most used and developed human fingers (the index and the middle), and requires those fingers to work only in one biologically natural direction—to bend along the bone axial line. Together these principles allow a user of this invention to type intuitively fast, without thinking about finger positions, or checking the current choice of case. The invention requires no front space on the device, and therefore allows to relieve future designs of the applicable embodiments of the need to include an equivalent of a traditional keyboard.

### SUMMARY OF THE INVENTION

This invention provides an improved method of text input via chords, accomplished by the fingers pressing on specifically assigned input zones while positioned on the device in a prescribed order.

In accordance with one embodiment of the invention, in a handheld mobile device, twelve input zones positioned on the back of the device provide all the required functionality of text input currently achieved by the traditional keyboard.

### DRAWINGS

### Figures

In the drawings, closely related figures demonstrate this invention's application to one of the embodiments—a handheld mobile device.

FIG. 1 shows the most usual way people hold a mobile device when entering text, front view.

FIG. 2 shows the same way of holding the device, back view.

FIG. 3 shows finger adduction/abduction (move sideways to its axial line).

FIG. 4 shows finger flexion/extension (move along its axial line).

FIG. 5 shows positioning of the input zones for the finger's move along its axial line.

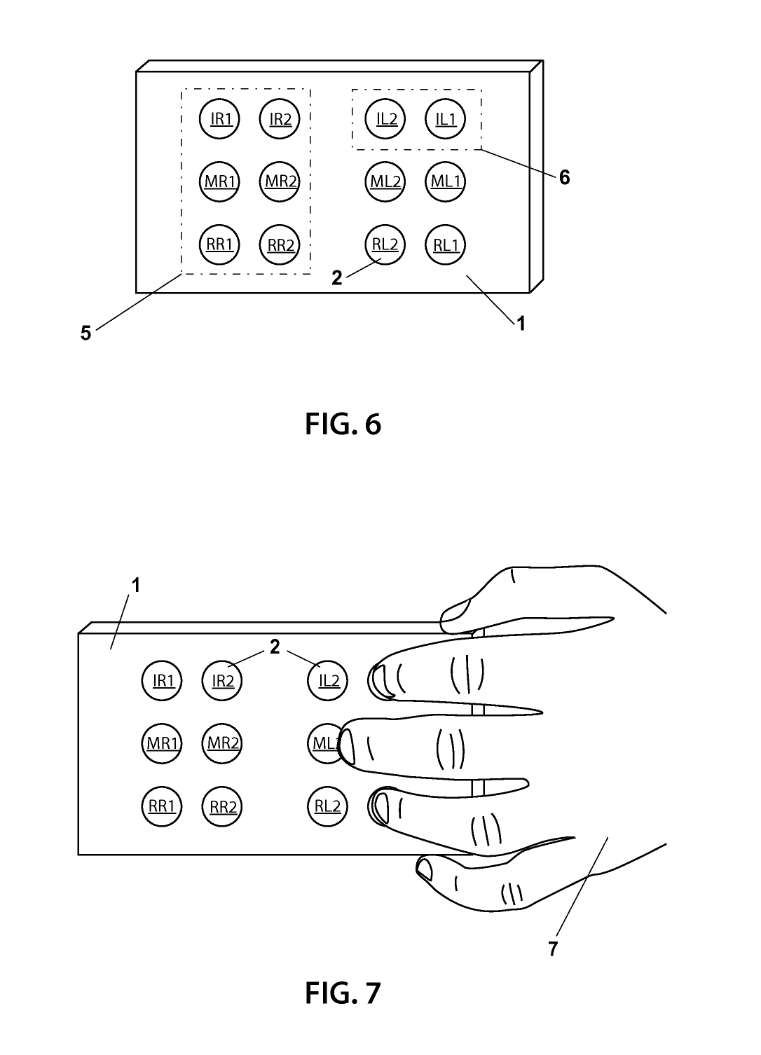

FIG. 6 shows detailed mapping of the input zones for each of the fingers. (View from the back of the device.)

FIG. 7 shows placement of the fingers over the input zones.

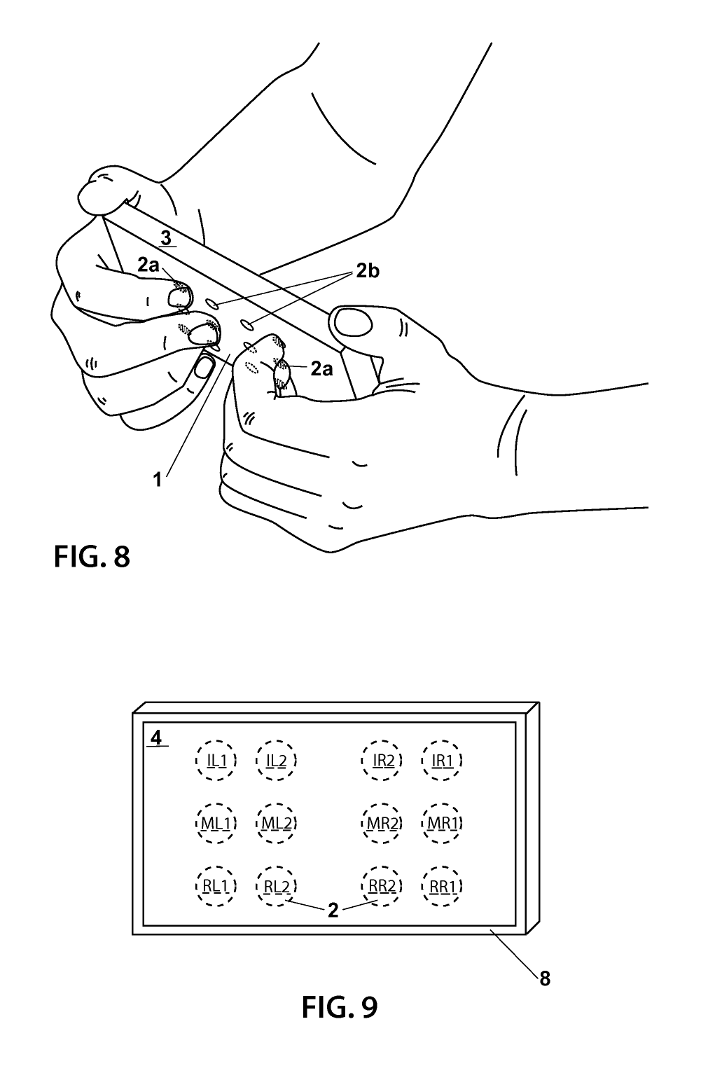

FIG. 8 shows positioning of the input zones on the back of the mobile device.

FIG. 9 shows mapping of the input zones for each of the fingers. (Through view from the front of the device.)

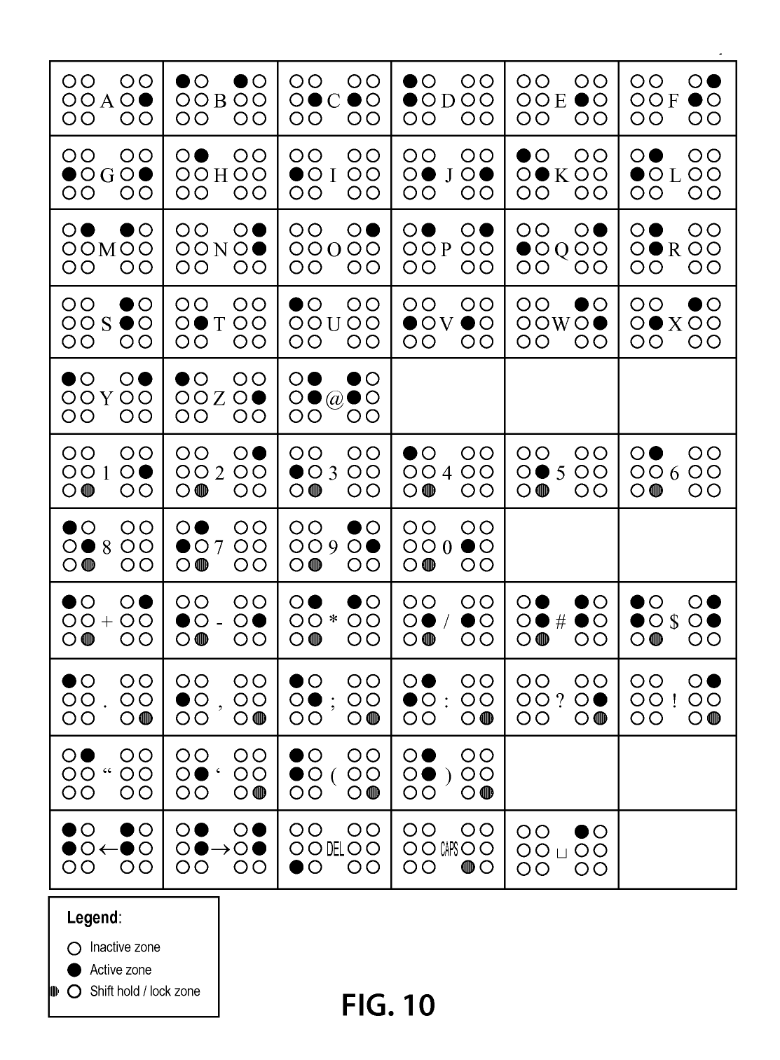

FIG. 10 shows a translation table of chords to English letters, numbers and other characters, with legend.

### LIST OF REFERENCE NUMERALS

1—Back of mobile device.
2—Input zones.
2a—Activated input zones.
2b—Inactive input zones.
3—Body of mobile device.
4—Front screen of mobile device.
5—Group of input zones (per hand).
6—Row of input zones (per finger).
7—Left hand.
8—Front of mobile device.
IR1 and IR2—input zones for index finger of right hand.
IL1 and IL2—input zones for index finger of left hand.
MR1 and MR2—input zones for middle finger of right hand.
ML1 and ML2—input zones for middle finger of left hand.
RR1 and RR2—input zones for ring finger of right hand.
RL1 and RL1—input zones for ring finger of left hand.

### DETAILED DESCRIPTION

### First Embodiment—FIGS. 1-10

As demonstrated in FIGS. 1 and 2, when held naturally, the back of the handheld device faces four fingers of each hand pressing against it. Three of these four fingers of each hand (Index, Middle and Ring fingers, referred to as “involved fingers”) will rest on the input zone rows as shown in FIG. 8. The Little finger is not assigned any rows and rests freely.

To achieve simplicity, each finger is assigned only two input zones to control and its position is limited to these zones. Input zones are positioned to allow the finger to move naturally, along its bone axial line [FIG. 4]. This invention does not require fingers to move sideways, as shown in FIG. 3, or to search for a position over the correct input zone.

The two input zones assigned for each finger make a row. Each row is assigned to a particular finger. There are 12 input zones dedicated on the back of the device [FIG. 6], organized in two groups—one for each hand. Each group consists of 3 rows, one for each finger: the top row is for the index finger, the middle row is for the middle finger and the bottom row is for the ring finger. Thus, each finger controls two input zones in one row. The complete set of the mapped input zones and finger placement over them are demonstrated in FIGS. 6 and 7. The input zones in FIGS. 6, 7 and 9 are coded by two letters and a number. The first letter denotes a finger (Index, Middle or Ring), the second letter denotes a hand (Left or Right), and the number denotes the input zone's number in a row.

FIG. 8 shows a perspective view of one version of embodiment of the invention. Here, input zones for text input are implemented on the back of the handheld device.

The input zones recognize one of two states—pressed/released or active/inactive.

Input zones can be materialized as buttons or sensors. Although it does not change the substance of this invention, I contemplate that the zones for this embodiment shall be made as separate buttons. FIG. 5 shows how a finger moves between the input zones materialized as buttons.

Input zones are equipped to send a signal to a decoding device. Although the signal can be transmitted by various kinds of technology, I contemplate for this embodiment to have it hard-wired within the handheld device.

A decoding device is a logical unit, implemented in hardware (as a microcontroller or a part of system-on-chip) or in software. The purpose of a decoding device is to translate sent signals from active and inactive input zones into a code assigned to each symbol, according to a translation table. Although the decoding device can be a separate microprocessor unit, for this embodiment I contemplate to have it coded as a set of instructions for the main CPU of the handheld mobile device to accept input zone signals and to decode them.

The number of ways to decode the patterns or to assign certain symbols to certain patterns is practically indefinite. Although it will not change the substance of this invention, I propose one decoding pattern for illustration purposes. FIG. 10 shows the proposed translation table. This table was developed based on the frequency of the American English alphabet letters in modern text. The more frequent the letter, the easier pattern is assigned to it. Also, the frequency of the most often used combinations of two letters was taken into consideration. The pictograms shown in the translation table correspond to the device input zones according to FIG. 9.

Activating more than one input zone simultaneously creates a unique combination that can be assigned a specific symbol/value. There are a total of 80 unique combinations that can be entered by the 4 involved fingers (2 from each hand). This amount allows entering every symbol in all phonetic alphabets (all European languages) or syllabic writing systems.

### Operation

### First Embodiment—FIGS. 1-10

The operation of the first embodiment requires the device to be held in the hands, as shown in FIGS. 1 and 2. The index, middle and ring fingers of each hand will be placed over the corresponding rows, each consisting of two input zones (or buttons), as shown in FIG. 8.

There are a total of 12 input zones, mapped as demonstrated in FIGS. 6, 7 and 9.

A finger activates an input zone (or presses a button), one of the two input zones available for each finger. For that purpose, the finger moves along its axial line, as shown in FIGS. 4 and 5. The layout of the input zones is purposely designed to eliminate the need for any finger to move sideways, as shown in FIG. 3.

Activated zones send a signal to the device's input recognition system. Inactive zones send a different signal or no signal at all. Therefore, active zones together with the inactive zones create a certain pattern. Entered patterns are translated into a corresponding symbol, in accordance with a translation table. Once the pattern is recognized, the corresponding symbol is selected and entered into the system. The further processing of the symbol will be identical and will be treated by the system the same way as any other method, including the symbols entered via a traditional keyboard.

One sample translation table is demonstrated in FIG. 10. There is a virtually unlimited number of ways to create different translation tables.

There are 4 kinds of combinations that can be dialed on the embodiment: one button by one hand; one button by each of two hands; two buttons by one hand; and two buttons by each of the hands.

Some national layouts consisting of more symbols will require two additional kinds, where one hand presses one button and the other presses two. However, such combinations should be avoided unless necessary, because it is subconsciously easier for a person to simultaneously press the same number of buttons with each hand.

The lowest row of zones (for the ring fingers) is reserved for additional functionality. As the translation table demonstrates, it is not required for entering textual symbols. Operating these input zones will allow a user to switch between English and other language layouts, to use shift or caps for just a few symbols, while pressed, or to activate shift-lock or caps-lock, as well as to activate such features as backspace and enter.

### CONCLUSION, RAMIFICATIONS, AND SCOPE

As demonstrated above, at least one embodiment of the invention provides a more ergonomic and productive method of text input, while utilizing fewer fingers and requiring almost no movement of either the user's hands or the device. Although the above description contains many specific details of one embodiment, these should not be considered as limitations on the scope, but rather as exemplifications of several preferred embodiments thereof. Many other variations are possible. For example, the invention can be embodied in tablet computers, e-readers, handheld translators, electronic mobile tour guides, remote controls for TV, media and entertainment devices, manipulators for game systems, or applications requiring separate pieces for each of the hands (such as if implemented on a steering wheel, bike bar, or any other manipulators held by hands separately or at a distance).

There are an equally large number of possible ramifications of this invention. Due to untested variations in size and shape, these ramifications have not been developed into separate embodiments or applications. The ramifications include different kinds of solutions available for implementing input zones—it can be conventional buttons, slider buttons or sensors (tactile, pressure, optical or temporal). The complete set of buttons can be embodied regardless of the direction in which device will be held—devices equipped with a gyro-sensor can establish which side is the “bottom” for the moment and re-assign rows of input zones accordingly. This ramification will require an additional row of input zones to make a 4×4 square matrix of 16 input zones in order to be effective in all four directions.

Ramifications also include the different ways the translation table can be structured, assigning different patterns to certain symbols. The table provided here is for illustration purposes only, although it was thought through to offer the most convenient and speedy way of entering symbols for a traditional US-English layout.

Accordingly, the scope should be determined not by the embodiments illustrated, but by the appended claims and their legal equivalents.

I claim:

1. A machine for entering symbols comprising of:
a. a set of input zones for user to put his hands on with means for assigning a set number of input zones for each of the set number of fingers of each hand, and
b. input zones designed with means for reacting to user's finger action, and
c. input zones designed to allow the fingers to remain in determined positions without the need to search for the input zones they need to touch for each entry of a symbol, and
d. a set of pre-defined patterns of activated zones, with means for establishing a correspondence between each combination and a single certain symbol, whereas there are possible assignments for each of all used symbols to a certain pattern, and
e. said set of pre-defined patterns of activated input zones, with means for utilizing a set number of fingers of each hand for entering each of all used symbols, and
f. said set of pre-defined patterns of activated zones, with means for utilizing the lowest finger of the set fingers exclusively for the functionality features of symbol input, such as shift, caps, shift-lock, caps-lock, backspace, delete, enter, case, menu access and for other similar functions, and
g. a system with means for comparing a collected pattern of activated zones with a pre-defined set of patterns, to determine the symbol that was entered, whereby said machine will allow the desired symbol to be entered, as a reaction to activation of certain zones by using a definite number of fingers to provide user with the possibility to enter all necessary symbols without switching between sets or cases, and to use the additional third finger to invoke all the remaining functional features of manipulating the device.

2. The set of zones of claim 1 wherein said set consists of twelve zones, two for each finger of three fingers of each hand, comprising of:
a. a set of zones for user to put his hands on, with means for assigning two zones for each of the three fingers of each hand, and
b. the zones arranged in a way that provides for exactly two zones to be assigned per one finger, and
c. said set of pre-defined patterns of activated zones, with means for utilizing only two fingers per each hand for each of all used symbols, and
d. said set of pre-defined patterns of activated zones, with means for utilizing the additional third finger exclusively for the functionality features of symbol input, such as shift, caps, shift-lock, caps-lock, backspace, delete, enter, case, menu access and for other similar functions, whereby said method will allow a desired symbol to be entered, as described in claim 1, by using only one to two fingers of each hand or both hands at once to provide the user with the possibility to enter all desired symbols without switching between sets or cases, and to use the additional third finger for all the remaining functional features of manipulating the device.

3. A machine for entering symbols as defined in the claim 1 to provide means for operating the same way in situations where the device is turned, comprising of:
a. the set of zones of claim 1 wherein said set consists of sixteen zones, two for each finger of three fingers of each hand, plus an additional row of four zones, and
b. the additional four zones to make the total set to be a matrix of 4 by 4 zones, and
c. means for assignment of twelve of the total sixteen zones, in accordance with the device's position, and
d. means for assignment of the lowest row of four of the total sixteen zones as disabled or non-reactive to user, in accordance with the device's position, and
e. means for assignment for three fingers of each hand to use two zones for each finger, and whereby said machine will allow a desired symbol to be entered, operating in all other respects in the way identical to the method described in claim 1, irrespective of the device's position or angle.

4. A machine for entering symbols as defined in the claim 1 to provide means for operating the same way in situations where the device is split in two separate forms, comprising of:
a. two sets of zones, separately for each hand, wherein each of the said sets consists of the half of the columns of zones defined in claim 1, and
b. means for a through assignment of all of the zones as they would be assigned if the zones were placed together, as defined in claim 1, and
c. a set of pre-defined patterns of active zones as defined in claim 1, with means for establishing a correspondence between the active zones from the sets of each hand simultaneously, as if they were activated as zones in claim 1, and
d. a system that compares a collected pattern of activated zones as in claim 1, as if the device had not been split, with a pre-defined set of patterns, to determine the symbol that was entered, whereby said machine will allow the desired symbol to be entered, irrespective of the device's form being materialized in two separate pieces.

5. The zones of claim 1 wherein said zones are materialized as conventional buttons.

6. The zones of claim 1 wherein said zones are materialized as sliding buttons.

7. The zones of claim 1 wherein said zones are materialized as sensors.

8. A method of entering symbols comprising of the following steps:
a. providing a set of zones for user to put his hands on, with means for assigning a set number of zones for each of the set number of fingers of each hand, and
b. providing the zones with means for reacting to user's finger action, and
c. placing the zones with means to allow the fingers to remain in determined positions without the need to search for the input zones they need to touch for each entry of a symbol, and
d. providing the set of pre-defined patterns of activated zones, with means for establishing a correspondence between each combination and a single certain symbol, whereas there are possible assignments for each of all used symbols to a certain pattern, and
e. providing such set of pre-defined patterns of activated zones, with means for utilizing a set number of fingers of each hand for entering each of all used symbols, and
f. providing such set of pre-defined patterns of activated zones, with means for utilizing the lowest finger of the set fingers exclusively for the functionality features of symbol input, such as shift, caps, shift-lock, caps-lock, backspace, delete, enter, case, menu access and for other similar functions, and
g. providing the system with means for comparing a collected pattern of activated zones with the pre-defined set of patterns, to determine the symbol that was entered, whereby said method will allow the desired symbol to be entered, as a reaction to activation of certain zones, by using a definite number of fingers to provide user with the possibility to enter all necessary symbols without switching between sets or cases, and to use the additional third finger to invoke all the remaining functionality of manipulating the device.
